(19) United States
(12) Patent Application Publication
(10) Pub. No.: US 2025/0217908 A1
(43) Pub. Date: Jul. 3, 2025

(54) LAND MARKET PRICE ESTIMATION SYSTEM AND METHOD HAVING FINAL PRICE CALCULATION UNIT

(71) Applicant: KOREA REAL ESTATE BOARD, Daegu (KR)

(72) Inventors: Jae Mun LEE, Pohang-si (KR); Jin Ho CHOI, Daegu (KR); Kyu Hyeon YANG, Gimpo-si (KR)

(21) Appl. No.: 17/768,978

(22) PCT Filed: Apr. 22, 2021
(86) PCT No.: PCT/KR2021/005061

§ 371 Date: Apr. 14, 2022

(30) Foreign Application Priority Data
May 14, 2020 (KR) 10-2020-0057689

(51) Int. Cl. G06Q 50/16; G06Q 30/0201

(52) U.S. Cl. CPC G06Q 50/16; G06Q 30/0206

(57) ABSTRACT

A land market price estimation system having a final price calculation unit according to the present invention includes: a database unit configured to collect and store officially announced price information, market price information, and land characteristic information; a price information maintenance unit configured to remove a characteristic inconsistency case and a price outlier case from the information of the database unit; a homogeneous land price area generation unit configured to generate a homogeneous land price area by using information maintained by the price information maintenance unit; a similar case extraction unit configured to extract one or more cases similar to a target land from the information generated by the homogeneous land price area generation unit; and a final price calculation unit configured to estimate the price of the target land from the similar cases extracted by the similar case extraction unit.

### TECHNICAL FIELD

The present invention relates to a land market price estimation system and method. More specifically, the present invention relates to a land market price estimation system and method having a final price calculation unit including a realization rate method-based trial price calculation unit and a reference comparison rate method-based trial price calculation unit.

### BACKGROUND ART

The government is implementing and operating various real estate policies to stabilize the real estate market, prevent speculation, and enhance housing welfare. The need for the estimation of market prices is increasing in order to diagnose the effects of real estate policies and understand regional situation changes. In response to this, the present applicant proposed a ‘System and Method for Calculating Real Estate Market Prices Using a Homogeneous Land Price Area and Actual Transaction Prices’ in Korean Patent No. 10-1762888.

As real estate transaction reporting became mandatory and related data is accumulated, basic data for the estimation of real estate prices is prepared. However, due to false reports, the intervention of circumstances, and trading bias in terms of region and type, it is necessary to reorganize and supplement actual transaction data.

In particular, even though similar cases are accurately extracted, an algorithm for calculating the final price of the extracted similar cases is not accurately presented, so that there is a problem in that a highly reliable final price cannot be calculated.

Furthermore, in Korean Patent No. 10-1773911, which is a preceding patent of the present applicant, a realization rate is calculated by simply comparing an officially announced price and an actual transaction price. However, this scheme has a problem in that it does not take into consideration price changes between the date (e.g., January 1) on which an officially announced land price was announced and a case time point.

### DISCLOSURE

### Technical Problem

A land market price estimation system and method having a final price calculation unit according to the present invention have the following technical problems:

First, the present invention intends to present an algorithm for calculating the final price of similar cases in detail.

Second, the present invention intends to be used for the verification of false sales in real transactions and the generation of trading price indices by estimating the market prices of nationwide land according to objective criteria, thereby enabling market management, research, and statistics regarding real estate to be systematized and objectively performed.

Third, the present invention intends to be used for the support of various government policies, such as the designation of a speculative zone, the management of the pre-sale housing market, and the simulation of policy introduction.

The technical problems to be solved by the present invention are not limited to those mentioned above, and other problems not mentioned will be clearly understood by those skilled in the art from the following description.

### Technical Solution

The present invention is directed to a system that is operated by a program executed by an arithmetic processing means including a computer and estimates the market price of a target land.

A land market price estimation system having a final price calculation unit according to the present invention includes: a database unit configured to collect and store officially announced price information, price market information, and land characteristic information; a price information maintenance unit configured to remove a characteristic inconsistency case and a price outlier case from the information of the database unit; a homogeneous land price area generation unit configured to generate a homogeneous land price area by using information maintained by the price information maintenance unit; a similar case extraction unit configured to extract one or more cases similar to a target land from the information generated by the homogeneous land price area generation unit; and a final price calculation unit configured to estimate the price of the target land from the similar cases extracted by the similar case extraction unit.

The final price calculation unit according to the present invention may include: a realization rate method-based trial price calculation unit configured to calculate a realization rate by comparing the price of each of the extracted cases and a temporally-corrected officially announced land price and then calculate a per-case trial price by dividing the corresponding realization rate by the officially announced land price of the target land; and a reference comparison rate method-based trial price calculation unit configured to calculate a per-case trial price by applying a reference comparison rate, which is a price difference rate according to the difference in physical characteristics between the target land and each of the extracted cases, to a price of the case.

The realization rate method-based trial price calculation unit according to the present invention may calculate a final trial price by weighting the per-case trial prices with the reciprocal of the distance to the target land and averaging them.

The final price calculation unit according to the present invention may include a price determination unit configured to: if a reference comparison rate method-based final trial price is included within a preset range for a realization rate method-based final trial price, select the realization rate method-based final trial price as a final calculated price; and, if the reference comparison rate method-based final trial price is not included within the preset range for the realization rate method-based final trial price, calculate a final calculated price by obtaining the arithmetic average of the reference comparison rate method-based final trial price and the realization rate method-based final trial price.

The final price calculation unit according to the present invention may include a confidence rating unit configured to assign a confidence level of any one of good, normal, and insufficient when the number of cases finally extracted is within a preset range.

The confidence rating unit according to the present invention may assign a confidence level lower than a reference level by one level when the price determination unit calculates a final price by obtaining the arithmetic average of a realization rate method-based final trial price and a reference comparison rate method-based final trial price.

In the present invention, the officially announced price information of the database unit may include officially announced reference land prices and officially announced individual land prices.

In the present invention, the market price information of the database unit may include at least one of use area information, use status information, land category information, area information, and road contact information.

In the present invention, the land characteristic information of the database unit may include at least one of transaction case prices, appraisal case prices, and regional survey case prices.

The price information maintenance unit according to the present invention may include a characteristic inconsistency case removal unit configured to remove case information in which land characteristic information included in officially announced price information and land characteristic information included in actual transaction information are different from each other.

The price information maintenance unit according to the present invention may include a price outlier case removal unit configured to remove case information in which a realization rate, which is the ratio of an officially announced individual land price, corrected for the time when an actual transaction is performed using a land price change rate, to an actual transaction price, is equal to or larger than a preset value.

The homogeneous land price area generation unit according to the present invention may include: a basic comparative group generation unit configured to classify lands having the same basic administrative area, the same use area, and the same use status as the same group; an arrangement unit configured to arrange lands within a basic comparative group based on their officially announced individual land prices; and a rating unit configured to assign grades to the arranged individual lands based on preset price intervals.

The present invention provides a land market price estimation method having a final price calculation unit, the land market price estimation method being configured in a form of a program executed by an arithmetic processing means including a computer and estimating a market price of a target land, the land market price estimation method including: step S1 of collecting and storing, by a database unit, officially announced price information, market price information, and land characteristic information; step removing, S2 of by a price information maintenance unit, a characteristic inconsistency case and a price outlier case from the information of the database unit; step S3 of generating, by a homogeneous land price area generation unit, a homogeneous land price area by using information maintained by the price information maintenance unit; step S4 of extracting, by a similar case extraction unit, one or more cases similar to a target land from the information generated by the homogeneous land price area generation unit; and step S5 of estimating, by a final price calculation unit, the price of the target land from the similar cases extracted by the similar case extraction unit.

In the present invention, the final price calculation unit of step S5 may include: a realization rate method-based trial price calculation unit configured to calculate a realization rate by comparing the price of each of the extracted cases and a temporally-corrected officially announced land price and then calculate a per-case trial price by dividing the corresponding realization rate by the officially announced land price of the target land; and a reference comparison rate method-based trial price calculation unit configured to calculate a per-case trial price by applying a reference comparison rate, which is a price difference rate according to the difference in physical characteristics between the target land and each of the extracted cases, to the price of the case.

In the present invention, the realization rate method-based trial price calculation unit of step S5 may calculate a final trial price by weighting the per-case trial prices with the reciprocal of the distance to the target land and averaging them.

The final price calculation unit according to the present invention may be configured to: if a reference comparison rate method-based final trial price is included within a preset range for a realization rate method-based final trial price, select the realization rate method-based final trial price as a final calculated price; and, if the reference comparison rate method-based final trial price is not included within the preset range for the realization rate method-based final trial price, calculate a final calculated price by obtaining the arithmetic average of the reference comparison rate method-based final trial price and the realization rate method-based final trial price.

The final price calculation unit according to the present invention may include a confidence rating unit configured to assign a confidence level of any one of good, normal, and insufficient when the number of cases finally extracted is within a preset range.

The present invention may be implemented as a computer program stored in a computer-readable recording medium in order to perform the land market price estimation method having a final price calculation unit according to the present invention in combination with hardware for processing information via software on a computer.

### Advantageous Effects

The land market price estimation system and method having a final price calculation unit according to the present invention have the following effects:

First, the present invention has an effect of calculating a realization rate method-based trial price and a reference comparison rate method-based trial price and then calculating a final price with high reliability by using the above trial prices.

Second, the present invention has an effect of generating general transaction indices and establishing transparent transaction order by providing fair market price references to the real estate market.

Third, the present invention has an effect of improving work efficiency and accuracy by using the system and the method for verification purposes when performing survey, statistics, and market management regarding real estate.

Fourth, the present invention has an effect of generating a virtuous cycle for system improvement through the improvement of the utilization of actual transaction data, the diagnosis of the appropriateness of transaction cases, etc.

The effects of the present invention are not limited to those mentioned above, and other effects not mentioned will be clearly understood by those skilled in the art from the following description.

### DESCRIPTION OF DRAWINGS

FIG. 1 shows the overall structure of a land market price estimation system having a final price calculation unit according to the present invention;

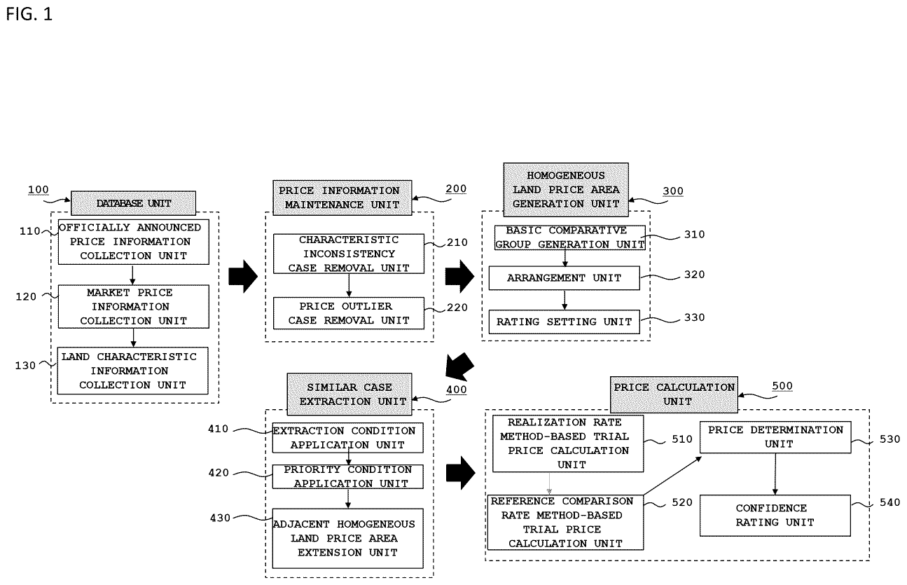

FIG. 2 shows the operation algorithm of a characteristic inconsistency case removal unit in a price information maintenance unit according to the present invention;

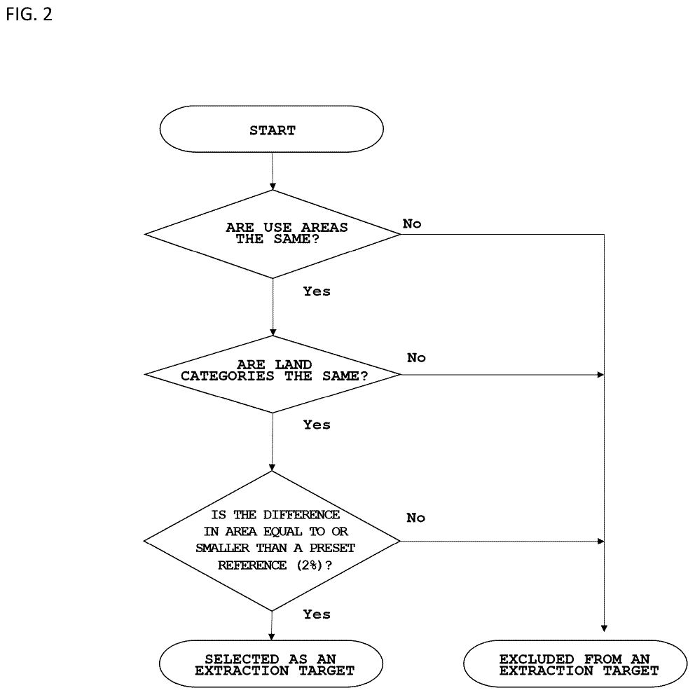

FIG. 3 shows the operation algorithm of a price outlier removal unit in the price information maintenance unit according to the present invention;

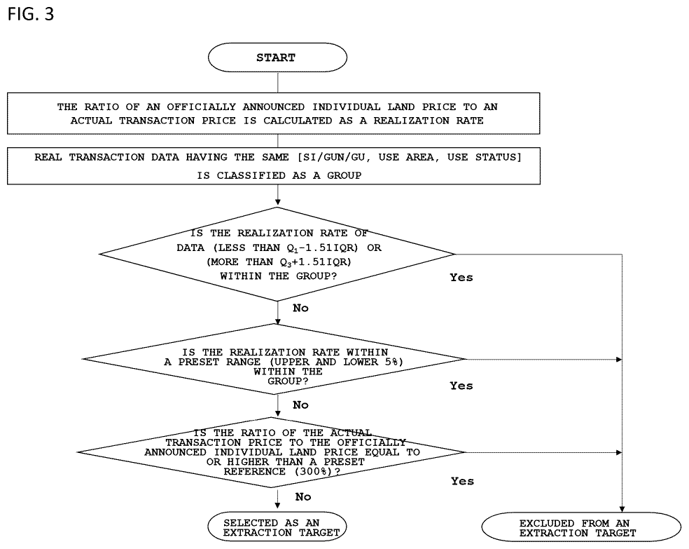

FIG. 4 shows the operation algorithm of an extraction condition application unit in a similar case extraction unit according to the present invention;

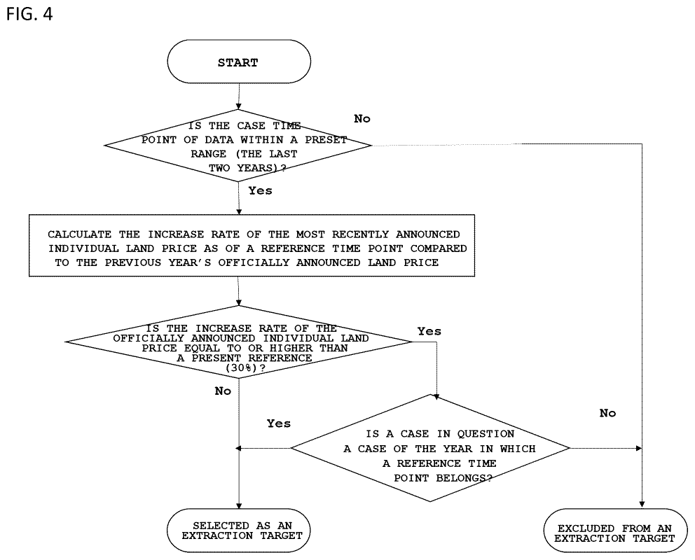

FIG. 5 shows the operation algorithm of a priority condition application unit in a similar case extraction unit according to the present invention;

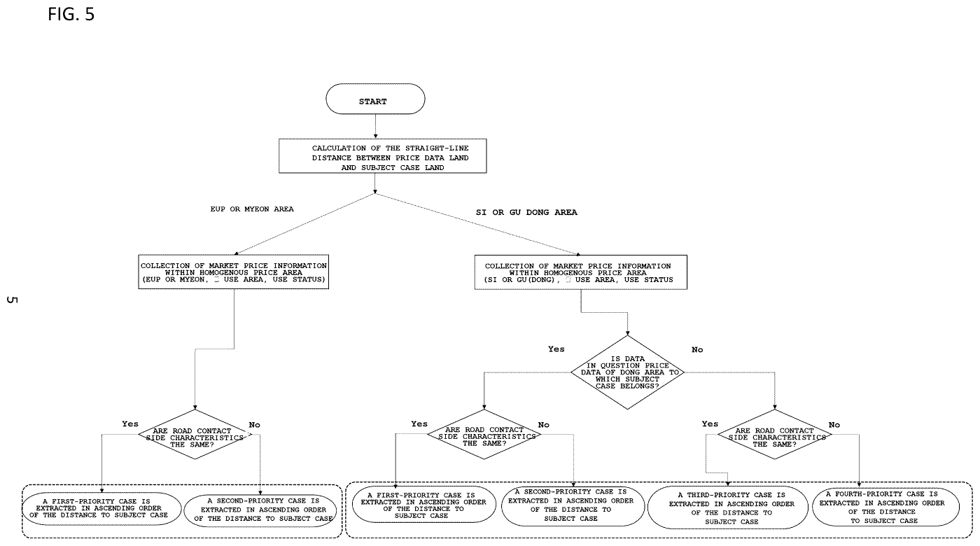

FIG. 6 shows the operation algorithm of an adjacent homogeneous land price area extension unit in the similar case extraction unit according to the present invention; and

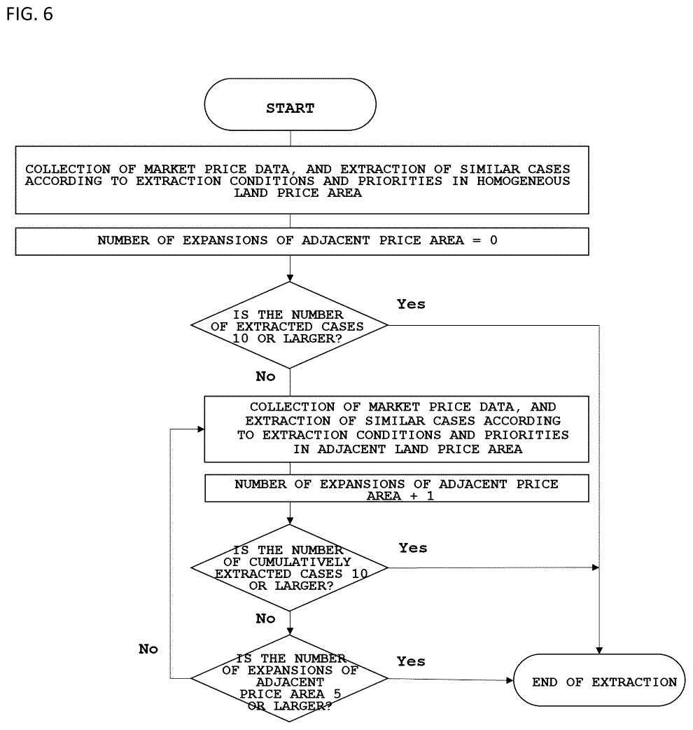

FIG. 7 is a comparison diagram comparing the land market price estimation system according to the present invention and a case.

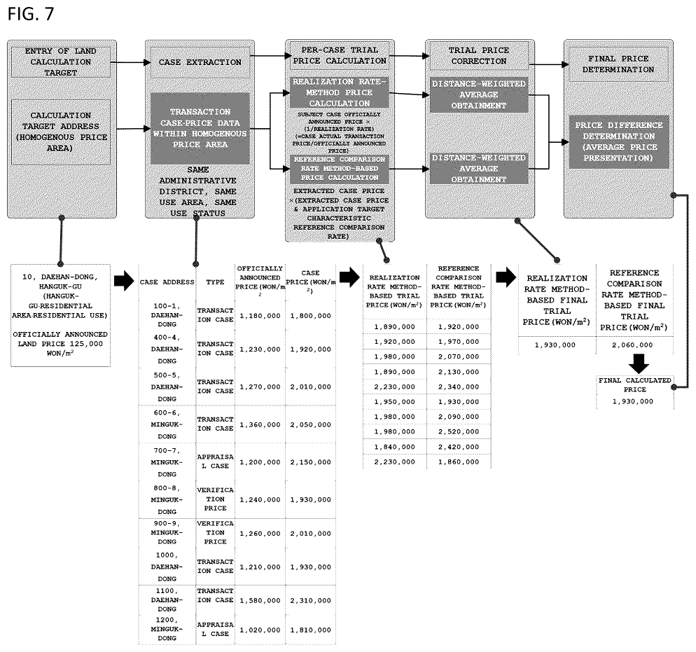

| | |
|---|---|
| 100: database unit | 110: officially announced price |
| | information collection unit |
| 120: market price information | |
| collection unit | |
| 130: land characteristic information | |
| collection unit | |
| 200: price information maintenance | |
| unit | |
| 210: characteristic inconsistency case | |
| removal unit | |
| 220: price outlier case removal unit | |
| 300: homogeneous land price area | |
| generation unit | |
| 310: basic comparative group | |
| generation unit | |
| 320: arrangement unit | 330: rating setting unit |
| 400: similar case extraction unit | 410: extraction condition |
| | application unit |
| 420: priority condition | 430: adjacent homogeneous land |
| application unit | price area extension unit |
| 500: price calculation unit | |

### BEST MODE

The present invention is directed to a system that is operated by a program executed by an arithmetic processing means including a computer and estimates the market price of a target land.

A land market price estimation system having a final price calculation unit according to the present invention includes: a database unit configured to collect and store officially announced price information, price market information, and land characteristic information; a price information maintenance unit configured to remove a characteristic inconsistency case and a price outlier case from the information of the database unit; a homogeneous land price area generation unit configured to generate a homogeneous land price area by using information maintained by the price information maintenance unit; a similar case extraction unit configured to extract one or more cases similar to a target land from the information generated by the homogeneous land price area generation unit; and a final price calculation unit configured to estimate the price of the target land from the similar cases extracted by the similar case extraction unit.

### Mode for Invention

Embodiments of the present invention will be described below so that those of ordinary skill in the art to which the present invention pertains can easily implement the present invention with reference to the accompanying drawings. As can be easily understood by those of ordinary skill in the art to which the present invention pertains, the embodiments described below may be modified in various forms without departing from the spirit and scope of the present invention. Identical or similar parts are denoted by the same reference numerals in the drawings as much as possible.

The technical terms used herein are intended merely to describe a specific embodiment, and is not intended to limit the present invention. As used herein, each singular form also includes a plural form unless the phrases clearly indicate the opposite.

The meaning of ‘including’ used herein specifies one or more specific features, regions, integers, steps, operations, elements and/or components, but does not exclude the presence or addition of another specific feature, region, integer, step, operation, element, component and/or group.

All terms including technical terms and scientific terms used herein have the same meanings as those commonly understood by those of ordinary skill in the art to which the present invention pertains. Terms defined in dictionaries are additionally interpreted as having meanings consistent with those described in the related art literature and the presently disclosed content. Unless defined, they are not to be construed in ideal or considerably formal senses.

Embodiments described herein may have at least one of hardware and software aspects. In this specification, each of a unit, a module, an apparatus, and a system may be a process, an object, an executable file, an executable thread, a program, and/or a computer.

The present invention will be described below with reference to the drawings. For reference, the drawings may be partially exaggerated in order to describe the features of the present invention. In this case, it is preferable to perform interpretation in light of the overall context of this specification.

The present invention is directed to a system that is operated by a program executed by an arithmetic processing means including a computer and that estimates the market price of a target land (hereinafter referred to as the ‘target land’) the market price of which is to be estimated.

A land market price estimation system having a final price calculation unit according to the present invention includes a database unit 100, a price information maintenance unit 200, a homogeneous land price area generation unit 300, a similar case extraction unit 400, and a final price calculation unit 500.

The database unit 100 according to the present invention may collect and store officially announced price information, market price information, and land characteristic information.

The price information maintenance unit 200 according to the present invention may remove a characteristic inconsistency case and a price outlier case from the information of the database unit 100.

The homogeneous land price area generation unit 300 according to the present invention may generate a homogeneous land price area by using the information maintained by the price information maintenance unit 200.

The similar case extraction unit 400 according to the present invention may extract one or more cases similar to the target land from the information generated by the homogeneous land price area generation unit 300.

The final price calculation unit 500 according to the present invention may estimate the price of the target land from the similar cases extracted by the similar case extraction unit 400.

In the present invention, the final price calculation unit 500 may include: final price calculation unit of step S5 includes: the realization rate method-based trial price calculation unit 510 configured to calculate a realization rate by comparing the price of each of the extracted cases and a temporally-corrected officially announced land price and then calculate a per-case trial price by dividing the corresponding realization rate by an officially announced land price of the target land; and a reference comparison rate method-based trial price calculation unit 520 configured to calculate a per-case trial price by applying a reference comparison rate, which is a price difference rate according to the difference in physical characteristics between the target land and each of the extracted cases, to the price of the case.

First, the database unit 100 according to the present invention will be described.

The database unit 100 according to the present invention includes an officially announced price information collection unit 110, a market price information collection unit 120, and a land characteristic information collection unit 130.

The officially announced price information collected by the officially announced price information collection unit 110 according to the present invention includes officially announced reference land prices and officially announced individual land prices.

In this case, each of the officially announced reference land prices refers to a fair price per unit area obtained through survey and assessment as of January 1 of each year for a reference land selected by the Minister of Land, Infrastructure and Transport from among a group of lands that are generally recognized as having similar land use status, similar surrounding environments, and other similar natural and social conditions.

In addition, each of the officially announced individual land prices refers to a price per unit area determined and announced as of January 1 of each year by the head of a si/gun/gu to be used for the imposition of various taxes, such as national and local taxes, and for the calculation of land prices for the purposes prescribed by other laws and regulations.

The officially announced price information may be directly used to calculate the realization rate (the ratio of the officially announced price to the fair market price) for each comparative case and to review basic characteristics.

The market price information collected by the market price information collection unit 120 according to the present invention may include at least one of transaction case prices, appraisal case prices, and regional survey case prices.

The transaction cases according to the present invention include the cases disclosed by the Real Estate Transaction Management System (RTMS) of the Korean Ministry of Land, Infrastructure and Transport among the collective land transaction cases reported pursuant to Article 3 of the Korean Act on Report on Real Estate Transactions, Etc.

The appraisal cases according to the present invention include cases in which lands are appraised for pending litigation in court or auction pursuant to Article 10(4) of the Korean Act on Appraisal and Certified Appraisers.

The regional survey cases according to the present invention refer to market price cases for corresponding lands that are calculated or verified while specific survey personnel perform official real estate price announcement and statistics-related work. The survey personnel include, e.g., survey personnel of the Korea Appraisal Board or personnel entrusted with survey by the Korea Appraisal Board.

The market price information according to the present invention may be directly used to extract a comparative case for the estimation of the appropriate market price of a target land after the process of removing a characteristic inconsistency case and a price outlier case is performed.

For the description of the land market price estimation system according to the present invention, the transaction time point of a transaction case, the appraisal time point of an appraisal case, and the survey time point of a regional survey case are collectively referred to as a ‘case time point,’ and the transaction price of a transaction case, the appraisal price of an appraisal case, and the survey price of a regional survey case are collectively referred to as a ‘case price.’

The land characteristic information collected by the land characteristic information collection unit 130 according to the present invention may include at least one of use area information, use status information, land category information, area information, and road contact information.

The land characteristic information refers to basic characteristic data such as the use area, use status, land category, area, road contact, etc. of officially announced price data and market price data. The land characteristic information may be used to remove one or more physical inconsistency cases by comparing and reviewing the basic characteristics of officially announced price data and market price data. Furthermore, the land characteristic information may also be used to set up a case extraction area by constructing for groups each basic administrative area, each use area, and each use status. Moreover, the land characteristic information may also be used to apply extraction priority, such as the priority for preferentially extracting a case with the same road contact characteristic, when extracting comparative cases.

Next, the price information maintenance unit 200 according to the present invention will be described.

The maintenance of price information refers to the maintenance of actual transaction data that does not go through expert verification in market price data and, thus, needs to be reviewed for adequacy. Among transaction cases, there may be cases where the physical characteristics of a report object are incorrectly described, cases where a false declaration is made for tax reduction, and cases where a special circumstance, such as a family transaction, is involved and a price deviates from a normal market price, etc. Accordingly, they require review and maintenance.

In the present invention, through the process of removing one or more physical characteristic inconsistency cases and further removing one or more price outlier cases for the purpose of the maintenance of price data, the adequacy of actual transaction data used without maintenance in the past may be improved, and accurate price estimation may be made.

The price information maintenance unit 200 according to the present invention may include a characteristic inconsistency case removal unit 210 configured to remove case information in which land characteristic information included in officially announced price information and land characteristic information included in actual transaction information are different.

In the present invention, the removal of a physical characteristic inconsistency case means the step of removing data in which a use area, a use status, a land category, or an area included in officially announced price data and a use area, a use status, a land category, or an area included in actual transaction data are different.

Since the characteristic inconsistency case information may not be used as appropriate price information in that physical characteristics are a main factor influencing the price of a target land and physical characteristic inconsistency means that any one of the utilization information is erroneous data, it is desirable to remove it.

For example, when some of officially announced price data and actual transaction data are as follows, as shown in Table 1 below, cases 1, 4, and 5 will be removed as physical characteristic inconsistency cases.

TABLE 1

| | | Officially announced price data | | | Actual transaction data | | | |
|---|---|---|---|---|---|---|---|---|
| | | | Area | | | Area | | |
| Identification | | Use area | category | Area | Use area | category | Area | |
| 1 | 100-1, Hankuk- | residential | building | 100 m² | residential | building | 80 | m² |
| | dong | area | site | | area | site | | |
| 2 | 200-2, Hankuk- | residential | hybrid | 100 m² | residential | hybrid | 101 | m² |
| | dong | area | area | | area | area | | |
| 3 | 300-3, Hankuk- | commercial | building | 300 m² | commercial | building | 300 | m² |
| | dong | area | site | | area | site | | |
| 4 | 400-4, Hankuk- | planning | school | 400 m² | production | school | 400 | m² |
| | dong | management | site | | management | site | | |
| | | area | | | area | | | |
| 5 | 500-5, Hankuk- | agricultural | field | 500 m² | agricultural | building | 500 | m² |

| | | | |
|---|---|---|---|
| dong | and forestry | and forestry | site |
| | area | area | |

Case 1 is removed because the area of the officially announced price data and the area of the actual transaction data are different. The reason for this is that the difference in the area of the information is larger than a preset reference (e.g., 2%). In case 2, although areas are different from each other, it may be considered that there is no difference in area when the difference is smaller than the preset reference. Case 3 is determined to be a normal case because all presented physical characteristics are the same. Case 4 is removed because the use areas are different, and case 5 is removed because the land categories are different.

The price information maintenance unit 200 according to the present invention may include a price outlier case removal unit 220 configured to remove case information in which a realization rate, which is the ratio of an officially announced individual land price, corrected for the time when an actual transaction is performed using a land price change rate, to an actual transaction price, is equal to or larger than a preset value.

The removal of a price outlier case refers to the process of determining outliers that are difficult to recognize as having been obtained in the normal market such as an excessively low or high price attributable to a special circumstance such as a transaction between family members, a falsely reported transaction price for tax reduction, etc. according to preset criteria and removing the outliers from actual transaction data.

The price outlier case removal unit determines and removes a case where realization rate is extreme or a transaction amount itself is determined to be extreme. To this end, the ratio of an officially announced individual land price to the actual transaction price of actual transaction data (hereinafter referred to as the ‘realization rate’) is calculated.

$$Realization Rate = \frac{Temporally - corrected officially announced land price}{Actual transaction price} \qquad ( 1 )$$

The realization rate is calculated using the officially announced individual land price, corrected for the time when the actual transaction is performed using the land price change rate, and the actual transaction price. Thereafter, after the actual transaction data has been classified by ‘si, gun, gu-use area-use status,’ one or more outliers may be determined by checking the realization rate distribution of actual transaction data belonging to the same group.

In this case, the land price change rate refers to the increase rate index of a sample land by si/gun/gu and use area nationwide, which is announced every month pursuant to the Korean Act on Report on Real Estate Transactions, Etc. and the Korean Regulations on Investigation and Assessment of Land Price Change Rate. The land price change rate used for the temporal correction is selected according to the si, gun, or gu, and the use area to which a corresponding case belongs, and is calculated by multiplying one or more per-month land price change rates in a period from an official announcement reference date to the time when a transaction is performed.

In the determination of an outlier, the IQR outlier determination technique commonly used to remove statistical outliers is used, and at the same time, a case corresponding to preset outlier criteria (e.g., upper and lower 5%) in the realization rate distribution may be determined to be an outlier and then removed.

In this case, IQR is an abbreviation of InterQuartile Range, and means the difference between the 3rd quartile (Q3) and the 1st quartile (Q1) in statistics. The IQR outlier determination technique refers to a statistical technique that determines a value corresponding to a value (smaller than Q1−1.5IQR) or a value (larger than Q3+1.5IQR) to be an outlier.

Data in which the ratio of the actual transaction price to the officially announced individual land price is higher than a preset reference (e.g., 300%) is determined to be extreme and then removed. However, when it is determined that the average realization rate of a corresponding region has been raised, the reference may be adjusted and used.

Next, the homogeneous land price area generation unit 300 according to the present invention will be described.

The homogeneous land price area generation unit 300 according to the present invention includes: a basic comparative group generation unit 310 configured to classify lands having the same basic administrative area, the same use area, and the same use status as the same group; an arrangement unit 320 configured to arrange the lands within the basic comparative group based on their officially announced individual land prices; and a rating unit 330 configured to assign grades to the arranged individual lands based on preset price intervals.

The present invention estimates the market price of the target land by selecting and comparing the market price data of real estate similar to the target land. If dissimilar data is extracted and compared, price differences according to individual characteristic differences need to be corrected more. The reason for this is that the possibility that error occurs in the process of identifying and calculating a correction value increases. Accordingly, the accuracy of an estimated price may be improved only when the similarity of selected comparative cases is improved.

According to this point of view, the similarity of comparative cases may be improved primarily by setting a homogeneous land price area and extracting comparative cases only from the corresponding region or an adjacent region.

The homogeneous land price area refers to a regional range in which the factors that form land prices are relatively homogeneous and thus similar price levels are formed. Depending on how the factors that form land prices are defined, the homogeneous land price area may be set differently.

In the conventional concept of the homogeneous land price area, basic regions are classified according to the use area and use status of each si, gun, and gu, and homogeneous land price areas are classified according to preset price intervals. However, in the concept of the homogeneous land price area according to the present invention, the fact that factors that form land prices may be different even within the same si/gun/gu is taken into consideration, and basic administrative districts are classified as the legal dong area of a ‘si’ or ‘gu’ to which a corresponding dong belongs, or as the corresponding eup or myeon area of an ‘eup’ or ‘myeon’ area.

The homogeneous land price area generation unit 300 according to the present invention includes a basic comparative group generation unit 310, an arrangement unit 320, and a rating setting unit 330.

The basic comparative group generation unit 310 according to the present invention classifies lands having the same basic administrative district, the same use area, and the same use status as a group.

In the present invention, the basic administrative district is defined as the legal-dong area of a ‘si’ or ‘gu’ to which a legal dong belongs in the case of a legal dong district, or as an ‘eup’ or ‘myeon’ district in the case of the corresponding eup or myeon district. In this case, the legal dong district refers to an area including the legal dong district and other legal dong districts within the ‘si’ or ‘gu’ to which the former district belongs. For example, in the case of Seocho-dong, Seocho-gu, Seoul, the basic administrative district is all legal dong districts within Seocho-gu, including Seocho-dong. In the case of Hyeonpung-eup, Dalseong-gun, Daegu, only Hyeonpung-eup is the basic administrative district. Meanwhile, in Paju-si where legal dong districts and eup or myeon districts are mixed together, legal dong districts excluding the eup or myeon districts of Paju-si become the basic administrative district in the case of Unjeong-dong, Paju-si, Gyeonggi-do, and Jeokseong-myeon becomes the basic administrative district in the case of Jeokseong-myeon in Paju-si.

In the present invention, the use area refers to each of the areas determined by a si/gun management plan without overlapping in order to use lands economically and efficiently and promote public welfare by restricting the use of lands, the use of buildings, building-to-land ratio, floor area ratio, height, etc. pursuant to the Korean National Land Planning and Utilization Act.

In the present invention, use areas are divided into a residential area, a commercial area, an industrial area, a green area, a planned management area, a management area (excluding the planned management area), an agricultural and forestry area, a natural environment conservation area, and an area not designated for use. An area designated as a development restricted area pursuant to the Korean National Land Planning and Utilization Act is not a use area, but is considered a separate use area because restrictions and regulations under the Korean public act are strict.

In the present invention, the use status refers to the use status of reference land and surrounding land officially announced pursuant to the Korean Public Notice of Values and Appraisal of Real Estate Act, and may be divided into ‘residential use,’ ‘commercial use,’ ‘residential and commercial use’ where residential use and commercial use are combined together, ‘industrial use,’ ‘a field and paddy,’ and ‘forest land.’

The arrangement unit 320 according to the present invention arranges lands within a basic comparative group in ascending order based on their officially announced individual land prices. In this case, in the case of reference land, an officially announced reference land price is considered an officially announced individual land price.

The rating setting unit 330 according to the present invention assigns ratings to the arranged individual lands according to preset price levels.

For example, in the case of a basic comparison group in which the basic administrative district is Seocho-gu, Seoul, the use area is a residential area, and the use status is residential, the price interval is set to 300,000 won. Lands with an individual official land price of 0 to 300,000 won belong to price span 1, and lands with an individual official land price of 300,000 to 600,000 won belong to price span 2. This price interval may be set by taking into consideration the price difference and distribution of each basic comparative group.

Areas classified by the same price span within the basic comparative group become the ‘homogeneous land price area,’ and the ‘homogeneous land price area’ is used as a basic zone for extracting comparative examples.

The similar case extraction unit 400 according to the present invention may extract one or more cases similar to the target land from the information generated by the homogeneous land price area generation unit 300. The similar cases may be extracted by various methods.

For example, the similar case extraction unit 400 may include an extraction condition application unit 410 configured to apply the conditions for extracting one or more similar cases from the market price information within the homogeneous land price area generated by the homogeneous land price area generation unit 300, and a priority condition application unit 420 configured to extract one or more cases similar to the target land from the cases, extracted by the extraction condition application unit 410, by applying priority conditions.

The extraction condition application unit 410 according to the present invention may extract one or more similar cases by sequentially applying a first extraction condition for extracting market price information within a preset period, a second extraction condition for excluding corresponding case information when the ratio of the recently announced individual land price to a reference time point is increased by a preset value or more compared to the officially announced individual land price of a previous year, and a third extraction condition for extracting only the latest information when a plurality of pieces of market price information is present for the target land.

The priority condition application unit 420 according to the present invention may extract one or more similar cases by sequentially applying a first priority condition for preferentially extracting a case of a legal dong district to which the target land belongs when a basic administrative district is a legal dong district of a si or gu, a second priority condition for preferentially extracting a case having the same road contact characteristics, and a third priority condition for preferentially extracting a case that is closer to the target land when cases in question have the same dong district and the same road interface characteristics.

The similar case extraction unit 400 according to the present invention may include an adjacent homogeneous land price area extension unit 430 configured to, if the number of cases extracted from a homogeneous land price area is smaller than a preset number, extract one or more similar cases from a higher adjacent homogeneous land price area adjacent to the corresponding homogeneous land price area and a lower adjacent homogeneous land price area adjacent to the corresponding homogeneous land price area.

Next, the final price calculation unit 500 according to the present invention will be described.

The present invention includes the final price calculation unit 500 configured to estimate the price of the target land from the similar cases extracted by the similar case extraction unit 400.

The final price calculation unit 500 according to the present invention includes a realization rate method-based trial price calculation unit 510 configured to calculates a per-case trial price by calculating a realization rate by comparing the price of an extracted case and a temporally-corrected officially announced land price and dividing the corresponding realization rate by the officially announced land price of a target land.

Furthermore, the final price calculation unit 500 according to the present invention includes a reference comparison rate method-based trial price calculation unit 520 configured to calculate a per-case trial price by applying a reference comparison rate, which is a price difference ratio attributable to a difference in physical characteristics between a target land and a case, to the price of an extracted case.

The final price calculation unit 500 according to the present invention may calculate a final price by using various prices for an extracted similar case. For example, a realization rate method trial price and a reference comparison rate method trial price may be calculated, and a final price may be calculated using these prices.

A process in which the final price calculation unit 500 according to the present invention calculates a final price will be described more specifically below.

The realization rate method-based trial price calculation unit 510 according to the present invention may calculate a final trial price by weighting per-case trial prices with the reciprocal of the distance to the target land and averaging them, as shown in Equation 2 below:

$$Realization Rate Method - Based Final Trial Price = \begin{matrix}\frac{1}{{dist}_{1}} \times {price}_{1} + … + \frac{1}{{dist}_{5}} \times {price}_{5} \\ \frac{1}{{dist}_{1}} + … + \frac{1}{{dist}_{5}}\end{matrix} \times temporal correction value \qquad ( 2 )$$

where dist₁ and dist₅ are the straight-line distances between the target land and cases 1 and 5, and price₁ and price₅ are the ‘per-case trial prices’ of cases 1 and 5.

The realization rate method-based trial price calculation unit 510 may calculate a per-case trial price by calculating a realization rate by comparing an extracted case price and a temporally-corrected officially announced land price and dividing the corresponding realization rate by the officially announced land price of a target land.

In this case, the realization rate refers to the ratio of the ‘temporally-corrected officially announced land price’ to the case price.

The ‘temporally-corrected officially announced land price’ refers to a value (hereinafter referred to as the ‘temporal correction value’) obtained by multiplying the most recently officially announced land price by land price change rates in a period from the date (e.g., January 1) on which the officially announced land price was announced to a case time point.

In Korean Patent No. 10-1773911, which is a preceding patent of the present applicant, a realization rate is calculated by simply comparing an officially announced price and an actual transaction price. However, this scheme has a problem in that it does not take into consideration price changes between the date (e.g., January 1) on which an officially announced land price was announced and a case time point. Accordingly, an object of the present invention is to solve these problems.

On the assumption that the realization rate of the target land is similar to the realization rate of the extracted case, the appropriate market price of the target land may be estimated by dividing the officially announced land price of the target land by the per-case realization rate. This estimated price is referred to as the ‘per-case trial price.’ For example, when the 2020 officially announced land price (125,000 won) of the target land is divided by the actualization rate (0.66), the per-case trial price (189,000 won) may be calculated.

TABLE 2

| | | | | | Temporally- | | | | |
|---|---|---|---|---|---|---|---|---|---|
| Identification | | | | 2020 | corrected | | | | |
| (reference time | | Case | | officially | officially | | Per-case | Distance | |
| point: Jun. 1, | | time | Case | announced | announced | Realization | trial | to target | |
| 2020) | | point | price | land price | land price | rate | price | land | |
| Target land | | — | — | 1,250,000 | — | — | — | 0 | m |
| (10, Daehan- | | | | | | | | | |
| dong) | | | | | | | | | |
| 1 | 100-1, | May 1, | 1,800,000 | | 1,180,000 | 0.66 | 1,890,000 | 50 | m |
| | Daehan- | 2019 | | | | | | | |
| | dong | | | | | | | | |
| 4 | 400-4, | Feb. 1, | 1,902,000 | | 1,230,000 | 0.65 | 1,920,000 | 700 | m |
| | Daehan- | 2020 | | | | | | | |
| | dong | | | | | | | | |
| 5 | 500-5, | Mar. 15, | 2,010,000 | | 1,270,000 | 0.63 | 1,980,000 | 600 | m |
| | Daehan- | 2020 | | | | | | | |
| | dong | | | | | | | | |
| 6 | 600-6, | Dec. 1, | 2,050,000 | | 1,360,000 | 0.66 | 1,890,000 | 1000 | m |
| | Minguk- | 2019 | | | | | | | |
| | dong | | | | | | | | |
| 8 | 700-7, | Dec. 15, | 2,150,000 | | 1,200,000 | 0.56 | 2,230,000 | 1200 | m |
| | Minguk- | 2019 | | | | | | | |
| | dong | | | | | | | | |
| 9 | 800-8, | Jun. 1, | 1,930,000 | | 1,240,000 | 0.64 | 1,950,000 | 1500 | m |
| | Minguk- | 2020 | | | | | | | |
| | dong | | | | | | | | |
| 10 | 900-9, | May 15, | 2,010,000 | | 1,260,000 | 0.63 | 1,980,000 | 600 | m |
| | Minguk- | 2020 | | | | | | | |
| | dong | | | | | | | | |
| 11 | 1000, | Apr. 15, | 1,930,000 | | 1,210,000 | 0.63 | 1,980,000 | 200 | m |
| | Daehan- | 2020 | | | | | | | |
| | dong | | | | | | | | |
| 12 | 1100, | Dec. 15, | 2,310,000 | | 1,580,000 | 0.68 | 1,840,000 | 700 | m |
| | Daehan- | 2019 | | | | | | | |
| | dong | | | | | | | | |
| 13 | 1200, | Jul. 15, | 1,810,000 | | 1,020,000 | 0.56 | 2,230,000 | 1200 | m |
| | Minguk- | 2019 | | | | | | | |
| | dong | | | | | | | | |

In the above example, since ten cases are extracted as examples, ten per-case trial prices are calculated. The ten per-case trial prices are weighted by the reciprocal of the distance to the target land and then averaged (hereinafter referred to as ‘distance-weighted average’), which is achieved via Equation 2 above.

In Korean Patent No. 10-1773911, which is a preceding patent of the present applicant, the final realization rate is calculated by obtaining the distance-weighted average of the realization rates themselves and then calculated inversely to the officially announced land price. However, in the present invention, there is a clear difference in that per-case trial prices are calculating by inversely calculating the actualization rates for respective cases and then the distance-weighted average of the per-case trial prices is obtained.

The reason for proposing the configuration having the above-described difference is that it is determined that, given the purpose of the distance-weighted average to increase the influence of geographically adjacent objects, it is more reasonable to obtain the distance-weighted average of the prices of the corresponding land rather than the processed figure of the realization rates.

The price calculated through the distance-weighted average is calculated as 1,930,000 won in the above example, and the realization rate method-based final trial price is calculated by multiplying the temporal correction value in a period from a reference official announcement date to a reference time point by using the above-described land price change rate (however, in this example, it is assumed that the temporal correction value was 1.00, and thus it is also assumed that the final trial price is calculated as 1,930,000 won).

The reference comparison rate method-based trial price calculation unit 520 according to the present invention may calculate a per-case trial price by applying a reference comparison rate, which is a price difference ratio attributable to the difference in physical characteristics between the target land and a corresponding case, to the price of the extracted case.

The reference comparison rate method-based trial price calculation unit may calculate a per-case trial price by applying a price difference rate (hereinafter referred to as the ‘reference comparison rate’) attributable to the difference in physical characteristics between the target land and a corresponding case to the price of the extracted case.

The reference comparison rate refers to a comparison value in a reference comparison table (hereinafter referred to as the ‘land price reference comparison table’) prepared by the Minister of Land, Infrastructure and Transport for the factors for forming the prices of reference land and individual calculation target land pursuant to the Korean Public Notice of Values and Appraisal of Real Estate Act.

For example, when the individual characteristics of case 1 in Table 3 below are ‘gentle slope, Gwangdaehanmyeon’ while the individual characteristics of the target land are ‘flat land, Gwangdaehanmyeon,’ a per-case trial price (1,920,000 won) is calculated by multiplying the case price by the reference comparison rate (1.04×1.00=1.040) and then multiplying a multiplication results by a temporal correction value (1.02500) in a period from a case time point to a reference time point by using the land price change rate.

TABLE 3

| Identification | | | | | | | | | |
|---|---|---|---|---|---|---|---|---|---|
| (reference | | Case | | Reference comparison rate | | | | Temporal | Per-case |
| time point: | | time | Case | High and low | | Road contact | | correction | trial |
| Jun. 1, 2020) | | point | price | characteristic | | characteristic | | value | price |
| Target land | | — | — | flat | — | Gwangdaehanmyeon | — | | — |
| (10, Daehan- | | | | land | | | | | |
| dong) | | | | | | | | | |
| 1 | 100-1, | May 1, | 1,800,000 | gentle | 1.04 | Gwangdaehanmyeon | 1.00 | 1.02500 | 1,920,000 |
| | Daehan- | 2019 | | slope | | | | | |
| | dong | | | | | | | | |

According to the individual characteristics of ten extracted cases, the reference comparison rate, and the temporal correction value, trial prices for the ten cases are calculated as shown in Table 4 below:

TABLE 4

| | | | Reference comparison rate | | | | | | | |
|---|---|---|---|---|---|---|---|---|---|---|
| | | | High and low | | Road contact | | | Per- | | |
| Identification | Case price | | characteristic | | characteristic | | Temporal | case | Dista- | |
| Target land | | — | flat | — | Gwangdaehanmyeon | — | | — | 0 | m |
| (10, Daehan- | | | land | | | | | | | |
| dong) | | | | | | | | | | |
| 1 | 100-1, | 1,800,000 | gentle | 1.04 | Gwangdaehanmyeon | 1.00 | 1.02500 | 1,920,000 | 50 | m |
| | Daehan- | | slope | | | | | | | |
| | dong | | | | | | | | | |
| 4 | 400-4, | 1,920,000 | flat | 1.00 | Jungrokagji | 1.02 | 1.00500 | 1,970,000 | 700 | m |
| | Daehan- | | land | | | | | | | |
| | dong | | | | | | | | | |
| 5 | 500-5, | 2,010,000 | flat | 1.00 | Jungrokagji | 1.02 | 1.01000 | 2,070,000 | 600 | m |
| | Daehan- | | land | | | | | | | |
| | dong | | | | | | | | | |
| 6 | 600-6, | 2,050,000 | flat | 1.00 | Jungrohanmyeon | 1.03 | 1.00750 | 2,130,000 | 1000 | m |
| | Minguk- | | land | | | | | | | |
| | dong | | | | | | | | | |
| 8 | 700-7, | 2,150,000 | gentle | 1.04 | Sorokagji | 1.04 | 1.00780 | 2,340,000 | 1200 | m |
| | Minguk- | | slope | | | | | | | |
| | dong | | | | | | | | | |
| 9 | 800-8, | 1,930,000 | flat | 1.00 | Gwangdaehanmyeon | 1.00 | 1.00150 | 1,930,000 | 1500 | m |
| | Minguk- | | land | | | | | | | |
| | dong | | | | | | | | | |
| 10 | 900-9, | 2,010,000 | gentle | 1.04 | Gwangdaehanmyeon | 1.00 | 1.00200 | 2,090,000 | 600 | m |
| | Minguk- | | slope | | | | | | | |
| | dong | | | | | | | | | |
| 11 | 1000, | 1,930,000 | steep | 1.30 | Gwangdaehanmyeon | 1.00 | 1.00300 | 2,520,000 | 200 | m |
| | Daehan- | | slope | | | | | | | |
| | dong | | | | | | | | | |
| 12 | 1100, | 2,310,000 | flat | 1.00 | Sorokagji | 1.04 | 1.00770 | 2,420,000 | 700 | m |
| | Daehan- | | land | | | | | | | |
| | dong | | | | | | | | | |
| 13 | 1200, | 1,810,000 | flat | 1.00 | Gwangdaehanmyeon | 1.00 | 1.03000 | 1,860,000 | 1200 | m |
| | Minguk- | | land | | | | | | | |
| | dong | | | | | | | | | |

In this step, the final trial price is calculated through the distance-weighted average as in the realization rate method-based trial price calculation unit. In the corresponding example, the final trial price is calculated as 2,060,000 won.

The final price calculation unit 500 according to the present invention may include a price determination unit 530 configured to, if a reference comparison rate method-based final trial price is included within a preset range for a realization rate method-based final trial price, select the realization rate method-based final trial price as a final calculated price and to, if the reference comparison rate method-based final trial price is not included within the preset range for the realization rate method-based final trial price, calculate a final calculated price by obtaining the arithmetic average of the reference comparison rate method-based final trial price and the realization rate method-based final trial price.

When a reference comparison rate method-based final trial price is included within a preset range (e.g., 10%) for a realization rate method-based final trial price, the realization rate method-based final trial price is determined to be a final calculated price. Otherwise, a final calculated price may be determined by obtaining the arithmetic average of the two types of final trial prices.

In the above example, the realization rate method-based final trial price is calculated as 1,930,000 won, whereas the reference comparison rate method-based final trial price is calculated as 2,060,000 In this case, won. the reference comparison rate method-based final trial price is included within 10% (1,737,000 won to 2,123,000 won) of the realization rate method-based final trial price, so that the realization rate method-based final trial price (1,930,000 won) may be determined to the final calculated price.

The final price calculation unit 500 according to the present invention may include a confidence rating unit 540 configured to assign a confidence level of any one of good, normal, and insufficient when the number of cases finally extracted is within a preset range.

When the price determination unit 530 calculates the final price by obtaining the arithmetic average of the realization rate method-based final trial price and the reference comparison rate method-based final trial price, the confidence rating unit 540 according to the present invention may assign a confidence level lower than a reference level by one level.

For example, the confidence level ‘good’ is assigned when the number of finally extracted cases is six or more, the confidence level ‘normal’ is assigned when the number of finally extracted cases is three or more and five or less, the confidence level ‘insufficient’ is assigned when the number of finally extracted cases is one or more and two or less, and a confidence level is not calculated when the number of finally extracted cases is zero.

When a final price is determined by obtaining the arithmetic average of a final trial price based on the realization rate method-based trial price calculation unit 510 and a final trial price based on the reference comparison rate method-based trial price calculation unit 520, the confidence level ‘good’ may be adjusted to ‘normal’, and the confidence level ‘normal’ may be adjusted to ‘insufficient.’

Meanwhile, the present invention may be implemented as a method that is configured in the form of a program executed by an arithmetic processing means including a computer and estimates the market price of a target land. In the present invention, although the land market price estimation method is different from the land market price estimation system in terms of the category of the invention, they share the essential operating principle of the invention. Accordingly, overlapping portions will be excluded, and the following description will be given with a focus on the gist of the method.

A land market price estimation method having a final price calculation unit according to the present invention may include: step S1 of collecting and storing, by the database unit 100, officially announced price information, market price information, and land characteristic information; step S2 of removing, by the price information maintenance unit 200, a characteristic inconsistency case and a price outlier case from the information of the database unit 100; step S3 of generating, by the homogeneous land price area generation unit 300, a homogeneous land price area by using the information maintained by the price information maintenance unit 200; step S4 of extracting, by the similar case extraction unit 400, one or more cases similar to a target land from the information generated by the homogeneous land price area generation unit 300; and step S5 of estimating, by the final price calculation unit 500, the price of the target land from the similar cases extracted by the similar case extraction unit 400.

The final price calculation unit 500 of step S5 may include: the final price calculation unit of step S5 includes: the realization rate method-based trial price calculation unit 510 configured to calculate a realization rate by comparing the price of each of the extracted cases and a temporally-corrected officially announced land price and then calculate a per-case trial price by dividing the corresponding realization rate by an officially announced land price of the target land; and the reference comparison rate method-based trial price calculation unit 520 configured to calculate a per-case trial price by applying a reference comparison rate, which is a price difference rate according to the difference in physical characteristics between the target land and each of the extracted cases, to the price of the case.

In the present invention, the final price calculation unit 500 of step S5 may calculate the final trial price by weighting the per-case trial prices with the reciprocal of the distance to the target land and averaging them, as shown in the next Equation. In the present invention, the final price calculation unit 500 of step S5 may include the price determination unit 530 configured to, if a reference comparison rate method-based final trial price is included within a preset range for a realization rate method-based final trial price, select the realization rate method-based final trial price as a final calculated price and to, if the reference comparison rate method-based final trial price is not included within the preset range for the realization rate method-based final trial price, calculate a final calculated price by obtaining the arithmetic average of the reference comparison rate method-based final trial price and the realization rate method-based final trial price.

In the present invention, the final price calculation unit 500 of step S5 may include the confidence rating unit 540 configured to assign a confidence level of any one of good, normal, and insufficient when the number of cases finally extracted is within a preset range.

Meanwhile, the present invention may be implemented in the form of a computer program. The present invention may be implemented as a computer program stored in a computer-readable storage medium in order to perform the land market price estimation method having a final price calculation unit according to the present invention in combination with hardware for processing information via software on a computer.

The operations performed in the present invention may be performed within digital electronic circuitry, computer hardware, firmware, or combinations thereof. Features may be performed in a computer program product implemented in a storage device in a machine readable storage device, for example, for execution by a programmable processor. Furthermore, features may be performed by a programmable processor executing a program of instructions for performing the functions of the described embodiments through operation on input data and the generation of output. The described features may be performed on a programmable system including at least one programmable processor, at least one input device, and at least one output device that are coupled to receive data and instructions from a data storage system and to transmit data and instructions to the data storage system.

The embodiments described herein and the accompanying drawings are merely illustrative of some of the technical spirit included in the present invention. Accordingly, the embodiments disclosed herein are not intended to limit the technical spirit of the present invention, but are intended to describe the technical spirit of the present invention. It will be apparent that the scope of the technical spirit of the present invention is not limited by these embodiments. All modifications and specific embodiments that may be easily inferred within the scope of the technical spirit included in the specification and accompanying drawings of the present invention by those skilled in the art should be interpreted as being included in the scope of the present invention.

1. A land market price estimation system having a final price calculation unit, the land market price estimation system being operated by a program executed by an arithmetic processing means including a computer and estimating a market price of a target land, the land market price estimation system comprising:
a database unit configured to collect and store officially announced price information, market price information, and land characteristic information;
a price information maintenance unit configured to remove a characteristic inconsistency case and a price outlier case from the information of the database unit;
a homogeneous land price area generation unit configured to generate a homogeneous land price area by using information maintained by the price information maintenance unit;
a similar case extraction unit configured to extract one or more cases similar to a target land from the information generated by the homogeneous land price area generation unit; and
a final price calculation unit configured to estimate a price of the target land from the similar cases extracted by the similar case extraction unit;
wherein the final price calculation unit includes:
a realization rate method-based trial price calculation unit configured to calculate a realization rate by comparing a price of each of the extracted cases and a temporally-corrected officially announced land price and then calculate a per-case trial price by dividing the corresponding realization rate by an officially announced land price of the target land; and
a reference comparison rate method-based trial price calculation unit configured to calculate a per-case trial price by applying a reference comparison rate, which is a price difference rate according to a difference in physical characteristics between the target land and each of the extracted cases, to a price of the case.

2. The land market price estimation system of claim 1, wherein the realization rate method-based trial price calculation unit calculates a final trial price by weighting the per-case trial prices with a reciprocal of a distance to the target land and averaging them, as shown in Equation below:
$$Realization Rate Method - Based Final Trial Price = \frac{\frac{1}{{dist}_{1}} \times {price}_{1} + … + \frac{1}{{dist}_{5}} \times {price}_{5}}{\frac{1}{{dist}_{1}} + … + \frac{1}{{dist}_{5}}} \times temporal correction value$$
where dist₁ and dist₅ are straight-line distances between the target land and cases 1 and 5, and price₁ and price₅ are ‘per-case trial prices’ of cases 1 and 5.

3. The land market price estimation system of claim 2, wherein the final price calculation unit includes a price determination unit configured to:
if a reference comparison rate method-based final trial price is included within a preset range for a realization rate method-based final trial price, select the realization rate method-based final trial price as a final calculated price; and
if the reference comparison rate method-based final trial price is not included within the preset range for the realization rate method-based final trial price, calculate a final calculated price by obtaining an arithmetic average of the reference comparison rate method-based final trial price and the realization rate method-based final trial price.

4. The land market price estimation system of claim 1, wherein the final price calculation unit includes a confidence rating unit configured to assign a confidence level of any one of good, normal, and insufficient when a number of cases finally extracted is within a preset range.

5. The land market price estimation system of claim 4, wherein the confidence rating unit assigns a confidence level lower than a reference level by one level when the price determination unit calculates a final price by obtaining an arithmetic average of a realization rate method-based final trial price and a reference comparison rate method-based final trial price.

6. The land market price estimation system of claim 1, wherein the officially announced price information of the database unit includes officially announced reference land prices and officially announced individual land prices.

7. The land market price estimation system of claim 1, wherein the market price information of the database unit includes at least one of use area information, use status information, land category information, area information, and road contact information.

8. The land market price estimation system of claim 1, wherein the land characteristic information of the database unit includes at least one of transaction case prices, appraisal case prices, and regional survey case prices.

9. The land market price estimation system of claim 1, wherein the price information maintenance unit includes a characteristic inconsistency removal case unit configured to remove case information in which land characteristic information included in officially announced price information and land characteristic information included in actual transaction information are different.

10. The land market price estimation system of claim 1, wherein the price information maintenance unit includes a price outlier case removal unit configured to remove case information in which a realization rate, which is a ratio of an officially announced individual land price, corrected for a time when an actual transaction is performed using a land price change rate, to an actual transaction price, is equal to or larger than a preset value.

11. The land market price estimation system of claim 1, wherein the homogeneous land price area generation unit includes:
a basic comparative group generation unit configured to classify lands having a same basic administrative area, a same use area, and a same use status as a same group;
an arrangement unit configured to arrange lands within a basic comparative group based on their officially announced individual land prices; and
a rating unit configured to assign grades to the arranged individual lands based on preset price intervals.

12. A land market price estimation method having a final price calculation unit, the land market price estimation method being configured in a form of a program executed by an arithmetic processing means including a computer and estimating a market price of a target land, the land market price estimation method comprising:
step S1 of collecting and storing, by a database unit, officially announced price information, market price information, and land characteristic information;
step S2 of removing, by a price information maintenance unit, a characteristic inconsistency case and a price outlier case from the information of the database unit;
step S3 of generating, by a homogeneous land price area generation unit, a homogeneous land price area by using information maintained by the price information maintenance unit;
step S4 of extracting, by a similar case extraction unit, one or more cases similar to a target land from the information generated by the homogeneous land price area generation unit; and
step S5 of estimating, by a final price calculation unit, a price of the target land from the similar cases extracted by the similar case extraction unit;
wherein the final price calculation unit of step S5 includes:
a realization rate method-based trial price calculation unit configured to calculate a realization rate by comparing a price of each of the extracted cases and a temporally-corrected officially announced land price and then calculate a per-case trial price by dividing the corresponding realization rate by an officially announced land price of the target land; and
a reference comparison rate method-based trial price calculation unit configured to calculate a per-case trial price by applying a reference comparison rate, which is a price difference rate according to a difference in physical characteristics between the target land and each of the extracted cases, to a price of the case.

13. The land market price estimation method of claim 12, wherein the realization rate method-based trial price calculation unit of step S5 calculates a final trial price by weighting the per-case trial prices with a reciprocal of a distance to the target land and averaging them, as shown in Equation below:
$$Realization Rate Method - Based Final Trial Price = \frac{\frac{1}{{dist}_{1}} \times {price}_{1} + … + \frac{1}{{dist}_{5}} \times {price}_{5}}{\frac{1}{{dist}_{1}} + … + \frac{1}{{dist}_{5}}} \times temporal correction value$$
where dist₁ and dist₅ are straight-line distances between the target land and cases 1 and 5, and price₁ and price₅ are ‘per-case trial prices’ of cases 1 and 5.

14. The land market price estimation method of claim 12, wherein the final price calculation unit includes a price determination unit configured to:
if a reference comparison rate method-based final trial price is included within a preset range for a realization rate method-based final trial price, select the realization rate method-based final trial price as a final calculated price; and
if the reference comparison rate method-based final trial price is not included within the preset range for the realization rate method-based final trial price, calculate a final calculated price by obtaining an arithmetic average of the reference comparison rate method-based final trial price and the realization rate method-based final trial price.

15. The land market price estimation method of claim 12, wherein the final price calculation unit includes a confidence rating unit configured to assign a confidence level of any one of good, normal, and insufficient when a number of cases finally extracted is within a preset range.

16. A computer program stored in a computer-readable recording medium in order to perform the land market price estimation method having a final price calculation unit according to claim 12 in combination with hardware for processing information via software on a computer.
